(19) United States
(12) Patent Application Publication
(10) Pub. No.: US 2026/0158583 A1
(43) Pub. Date: Jun. 11, 2026

(54) PRESSURE-REGULATING INERTIAL FRICTION WELDING SYSTEM AND METHOD

(71) Applicant: Shandong University, Jinan (CN)

(72) Inventors: Guoliang QIN, Jinan (CN); Chang'an LI, Jinan (CN); Juan WANG, Jinan (CN)

(73) Assignee: Shandong University, Jinan (CN)

(21) Appl. No.: 19/329,356

(22) Filed: Sep. 15, 2025

(30) Foreign Application Priority Data
Dec. 6, 2024 (CN) 202411790307.6

(51) Int. Cl. B23K 20/12; B23K 37/02

(52) U.S. Cl. CPC B23K 20/123; B23K 20/125; B23K 20/126; B23K 37/0247

(57) ABSTRACT

A pressure-regulating inertial friction welding system and a method are provided. The pressure-regulating inertial friction welding system includes: an inertial friction welding machine including a flywheel set and a tailstock arranged oppositely, the flywheel set and the tailstock being provided with clamping assemblies, the flywheel set being connected to a rotation driving element, and the tailstock being connected to a servo feed assembly; and a control assembly including a controller, a strain gauge and a temperature monitor, the strain gauge being capable of measuring and obtaining strain data of the workpiece to be welded and sending the strain data to the controller, and the temperature monitor being capable of sending a temperature of the welding zone to the controller; and the controller being configured to control the servo feed assembly to regulate a pressure between the workpieces to be welded.

### CROSS-REFERENCE TO RELATED APPLICATION

This patent application claims the benefit and priority of Chinese Patent Application No. 202411790307.6 filed with the China National Intellectual Property Administration on Dec. 6, 2024, the disclosure of which is incorporated by reference herein in its entirety as part of the present application.

### TECHNICAL FIELD

The present disclosure relates to the field of inertial friction welding, and in particular, to a pressure-regulating inertial friction welding system and method.

### BACKGROUND

Inertial friction welding technology is an important welding method of axial-symmetry parts such as pipes and rods in the equipment manufacturing industry, which has the advantages such as low heat input and less welding defects and can achieve effective welding between homogeneous or heterogeneous metals. The typical welding process is as follows: before welding starts, a main motor is connected to a spindle and a flywheel set via a clutch, and drives the spindle and the flywheel set along with a workpiece clamped by the same to rotate, storing kinetic energy in the flywheel set and the spindle in rotation. When the rotational speed of the spindle and the flywheel set reaches a set value, the main motor is disengaged from the flywheel set and the spindle. When the welding process starts, a servo feed assembly drives a tailstock and a workpiece clamped by the same to axially move until the workpiece by the tailstock comes into contact with the workpiece in rotation. Under the action of the friction pressure and torque, the kinetic energy stored in the spindle and the flywheel set can be converted into thermal energy at friction interfaces between workpieces to heat the workpieces to a thermoplastic state, and then the workpieces are gradually extruded to form flash under the continuous action of the friction pressure, until the kinetic energy of the spindle and the flywheel set is exhausted and the spindle and the flywheel set are stopped. And the pressure is held for a certain time and then withdrawn, so that the welding is ended. The inertial friction welding technology mainly includes three welding parameters: moment of inertia, initial rotational speed and friction pressure. The moment of inertia is determined by the quality and dimension of the spindle and the flywheel set and cannot be changed after the welding process starts. The initial rotational speed depends on the set value before welding starts, and the rotational speed reduction in the welding process is spontaneous and cannot be directly controlled. The friction pressure is applied by a hydraulic system on a feed side and can be changed in the welding process.

Chinese Patent Publication No. CN 108637464 A discloses an inertial friction welding device, where a PLC is used for setting and controlling a pressure of a power pump set, a pressure of a first-stage pressure ratio regulation output, and a rotational speed of a power unit, detecting parameters in the welding process, and reading and storing welding data in the welding process. And a high-speed controller I is connected to a second-stage pressure servo ratio regulation output in a hydraulic system to regulate pressures of an upsetting cylinder and a hydraulic balance piston of a spindle in a host system, which can control the timing of the welding process. However, there is a lack of effective control measures after welding starts. For some special materials or thin-walled structural members, the high “post-peak” torque near the end of the welding is likely to cause buckling deformation, flash and cracks, which adversely affects the welding quality. The above problems result in the development of the inertial friction welding process needing a large number of trial and error tests to explore suitable process parameters, which consumes a large number of test materials, and increases the process development costs. Welding buckling deformation will reduce the yield rate, resulting in waste of production materials and increased production costs, and limiting popularization and application of the inertial friction welding technology.

### SUMMARY

An objective of the present disclosure is to provide a pressure-regulating inertial friction welding system and method with respect to the defects existing in the prior art, in which a strain gauge and a temperature monitor are used to obtain torques of workpieces to be welded and temperatures at welding friction interfaces in the welding process, and a servo feed assembly is used to regulate a pressure between the workpieces to be welded, thereby controlling the pressure and temperature precisely in the welding process and reducing quality problems such as buckling deformation and cracks and flash effectively.

A first objective of the present disclosure is to provide a pressure-regulating inertial friction welding system, which employs the following solution:
The pressure-regulating inertial friction welding system includes:
   an inertial friction welding machine including a flywheel set and a tailstock arranged oppositely, the flywheel set and the tailstock being provided with clamping assemblies configured for clamping a rotation workpiece to be welded and a feed workpiece to be welded respectively, the flywheel set being connected to a rotation driving element via a clutch, and the tailstock being connected to a servo feed assembly; and
a control assembly including a controller, a strain gauge and a temperature monitor, the strain gauge having an attaching surface to be attached to the feed workpiece to be welded corresponding to the tailstock and being capable of measuring and obtaining strain data of the feed workpiece to be welded and sending the strain data to the controller, the temperature monitor having a monitoring area covering welding zone between the rotation workpiece to be welded and the feed workpiece to be welded, and the temperature monitor being capable of sending a temperature of the welding zone to the controller; and the controller being configured to control the servo feed assembly to regulate a pressure between the rotation workpiece to be welded and the feed workpiece to be welded.

Furthermore, one, on the flywheel set, of the clamping assemblies forms a first clamping portion, an other, on the tailstock, of the clamping assemblies forms a second clamping portion, and the first clamping portion and the second clamping portion are coaxially arranged.

Furthermore, the inertial friction welding machine further includes a workbench, the workbench is provided with guide rails parallel to a movement direction of the servo feed assembly, and the tailstock matches with the guide rails to be slidably mounted on the workbench.

Furthermore, the strain gauge is connected to the controller via a strain-type torque meter, and the temperature monitor is an infrared temperature monitor.

Furthermore, an output end of the rotation driving element is connected to an input end of the clutch via a driving shaft, and an output end of the clutch is connected to the flywheel set via a rotating spindle.

Furthermore, the rotation driving element and the clutch are connected to the controller, and the controller is configured to control operating parameters of the rotation driving element and operating states of the clutch.

Furthermore, the servo feed assembly includes a hydraulic jack, one end of the hydraulic jack is fixed onto the inertial friction welding machine, and an other end of the hydraulic jack is connected to the tailstock to drive the tailstock to move relative to the flywheel set.

A second objective of the present disclosure is to provide an operating method of a pressure-regulating inertial friction welding system as described according to the first objective, which includes:
clamping the rotation workpiece to be welded and the feed workpiece to be welded by the one, on the flywheel set, of the clamping assemblies and the other, on the tailstock, of the clamping assemblies respectively, attaching the attaching surface of the strain gauge onto the feed workpiece to be welded corresponding to the tailstock, and monitoring, by a temperature monitor, a temperature at a friction interface between the rotation workpiece to be welded and the feed workpiece to be welded;
starting the rotation driving element to drive the one, on the flywheel set, of the clamping assemblies and the rotation workpiece to be welded to rotate to reach a set rotational speed, and cutting off power between the rotation driving element and the rotation workpiece to be welded by means of the clutch;
pushing, by the servo feed assembly, the tailstock and the feed workpiece to be welded to move to bring the rotation workpiece to be welded and the feed workpiece to be welded to come into contact and apply a pressure between the rotation workpiece to be welded and the feed workpiece to be welded;
continuously collecting the temperature at the friction interface between the rotation workpiece to be welded and the feed workpiece to be welded, and sending the temperature to the controller by the temperature monitor, and measuring and obtaining the strain data of the feed workpiece to be welded and sending the data to the controller by the strain gauge; and
controlling, by the controller, the pressure applied between the rotation workpiece to be welded the feed workpiece to be welded from the servo feed assembly based on the temperature collected by the temperature monitor and/or the strain data obtained by the strain gauge, to enable well welding of joint between the rotation workpiece to be welded and the feed workpiece to be welded.

Furthermore, the operating method includes: presetting a target temperature range of the friction interface, and controlling the servo feed assembly to increase, reduce or maintain the pressure applied between the rotation workpiece to be welded and the feed workpiece to be welded, to maintain the temperature of the friction interface within the target temperature range.

Furthermore, the operating method includes: presetting a target torque range of the feed workpiece to be welded, comparing a real-time torque collected by the strain gauge to the target torque range, and controlling the servo feed assembly to maintain the real-time torque within the target torque range.

Advantages and positive effects of the present disclosure compared to the prior art lie in the following:
(1) Aiming at the existing problems that cracks and flash may appear in welding area due to improper control of the welding pressure and temperature, and especially at the end stage of welding, buckling deformation of workpieces is easy to be occurred due to the high “post-peak” torque, a temperature monitor and a strain gauge are used to obtain temperature at welding friction interface and torque of the workpiece to be welded in the welding process respectively, a servo feed assembly is used to regulate a pressure between the workpieces to be welded, the temperature monitor is used to monitor the temperature in the inertial friction welding process, and deterioration of structure property caused by an over-high welding temperature is avoided by regulating the friction pressure, thereby improving quality of welding joint. With the strain gauge, torque monitoring in the inertial friction welding process can be achieved. The excessive post-peak torque can be avoided by regulating the friction pressure, thereby avoiding buckling deformation, improving welding formation, and effectively reducing quality problems such as the buckling deformation, cracks and flash.
(2) Based on the temperature monitoring data and the torque monitoring data, the friction pressure in the inertial friction welding process can be automatically regulated by means of the controller without damaging or changing the original mechanical structure of the inertial friction welding machine; with added external devices and an integrated data processing and control program, a friction torque, a friction heat generation rate, a welding duration, etc. can be changed by regulating the friction pressure in the welding process, thereby improving welding formation, improving welding quality, reducing development and application costs of the inertial friction welding process, and achieving simple operation and low costs.

### BRIEF DESCRIPTION OF THE DRAWINGS

The accompanying drawings of the specification, which form part of the present disclosure, are used to provide a further understanding of the present disclosure. The schematic embodiments of the present disclosure and their descriptions are intended to explain the present disclosure and do not constitute an undue limitation to the present disclosure.

FIG. 1 is a schematic diagram of a pressure-regulating inertial friction welding system in Examples I and II of the present disclosure.

In the drawings: 1. workbench; 2. rotation driving motor; 3. driving shaft; 4. clutch; 5. rotating spindle; 6. flywheel set; 7. clamping assembly; 8. tailstock; 9. hydraulic jack; 10. servo feed assembly; 11. guide rail; 12. controller; 13. strain gauge; 14. strain-type torque meter; 15. infrared temperature monitor; 16. rotation workpiece to be welded; and 17. feed workpiece to be welded.

### DETAILED DESCRIPTION OF THE EMBODIMENTS

### Example I

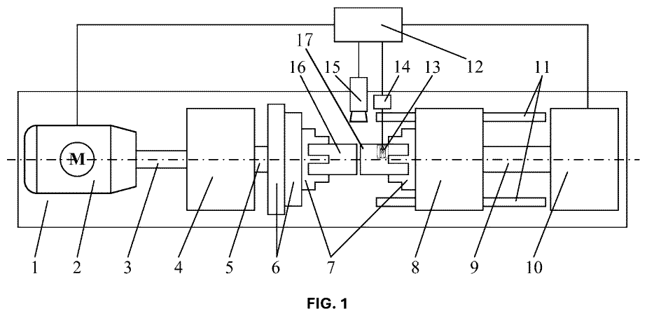

In an exemplary embodiment of the present disclosure, a pressure-regulating inertial friction welding system is shown in FIG. 1.

There is a lack of effective control measures after welding starts. For some special materials or thin-walled structural members, the large “post-peak” torque near the end of the welding is likely to cause buckling deformation, flash and cracks, and the like, which adversely affects the welding quality. Based on this, this embodiment provides a pressure-regulating inertial friction welding system, which improves the welding quality and yield by controlling precisely the pressure and temperature in the welding process, thereby reducing process development costs and waste of production materials.

As shown in FIG. 1, the pressure-regulating inertial friction welding system includes an inertial friction welding machine and a control assembly. The body of the inertial friction welding machine is a workbench 1, and a rotation driving element, a clutch 4, a flywheel set 6, a tailstock 8, a servo feed assembly 10 and guide rails 11 are arranged on the workbench 1. The flywheel set 6 is connected to the rotation driving element via the clutch 4 for storing and releasing rotational kinetic energy. The flywheel set 6 is provided with a clamping assembly 7, and the clamping assembly 7 forms a first clamping portion. The tailstock 8 is arranged opposite the flywheel set 6 for holding one end of a feed workpiece to be welded 17, and the tailstock 8 is also provided with a clamping assembly 7 which forms a second clamping portion. The first clamping portion and the second clamping portion are coaxially arranged, and they lie on the same straight line and coincide at the center point, which helps ensure the clamped workpieces maintain stable coaxiality during the welding process. The servo feed assembly 10 is connected to the tailstock 8 and configured to precisely control the relative position and pressure between the rotation workpiece to be welded 16 and the feed workpiece to be welded 17. The direction of the guide rail 11 is parallel to a movement direction of the servo feed assembly 10, so that movement directions of the tailstock 8 and the feed workpiece to be welded 17 clamped by the clamping assembly 7 on the tailstock 8 meet the requirements of inertial friction welding. The tailstock 8 matches with the guide rails 11 to be slidably mounted on the workbench 1. The tailstock 8 is moveable linearly on the workbench 1, thereby adjusting a distance between the tailstock 8 and the flywheel set 6.

The control assembly includes a controller 12, a strain gauge 13 and a temperature monitor. The controller 12 serves as the core of the system and is responsible for receiving data sent by sensors and issuing control commands. The strain gauge 13 is attached onto an attaching surface of the feed workpiece to be welded 17 corresponding to the tailstock 8, and is used for measuring strain data of the feed workpiece to be welded 17 to reflect deformation of the workpiece. The monitoring area of the temperature monitor covers the welding zone between the rotation workpiece to be welded 16 and the feed workpiece to be welded 17, such that temperature information of the welding zone can be obtained in real time.

The strain gauge 13 is connected to the controller 12 via a strain-type torque meter 14. The strain gauge 13 is used for monitoring torque changes generated in the welding process so as to reflect welding states. The temperature monitor is an infrared temperature monitor 15, which is also connected to the controller 12. The infrared temperature monitor 15 can monitor temperature changes in the welding zone in real time in a non-contact manner, ensuring that the welding process is carried out safely and controllably.

Specifically, as shown in FIG. 1, the infrared temperature monitor 15 is disposed adjacent to friction interface, such that the friction interface in the welding process is covered within a monitoring range of the infrared temperature monitor, and the infrared temperature monitor 15 is effectively connected to the controller 12. The infrared temperature monitor 15 may select an area and outputs temperature data of this area. The infrared temperature monitor 15 shall ensure that the central axis thereof is in the same plane as the friction interface. The strain-type torque meter 14 is disposed adjacent to the feed workpiece to be welded on a feed side and is effectively connected to the controller 12, and the strain gauge 13 is attached to an outer cylindrical surface, unclamped by the clamping assembly 7, of the feed workpiece to be welded on the feed side and is effectively connected to the strain-type torque meter 14.

In this example, the controller 12 is integrated with a data processing and control program, processes the collected temperature data and the torque data through the data processing and control program, and then controls the servo feed assembly 10 on the feed side to regulate the friction pressure in the welding process.

An output end of the rotation driving element is connected to an input end of the clutch 4 via a driving shaft 3, an output end of the clutch 4 is connected to the flywheel set 6 via a rotating spindle 5, and the controller 12 controls operating states of the rotation driving element and the clutch 4 to precisely control the rotational speed of the flywheel set 6. The rotation driving element may be an electric motor, a hydraulic motor, etc., and may be selected from a direct-current motor, an alternating-current motor, a servo motor or a stepper motor depending on the specific requirements. The clutch 4 may be an electromagnetic clutch, a pneumatic clutch or a hydraulic clutch, etc. The servo feed assembly 10 mainly includes a hydraulic jack 9, a fixture, a connector, a control system. One end of the hydraulic jack 9 is fixed onto the inertia friction welding machine and the other end of the hydraulic jack 9 is connected to the tailstock 8. By working in cooperation, it is ensured that the tailstock 8 is moveable smoothly and precisely relative to the flywheel set 6, thereby regulating the gap and contact pressure between the workpieces. The hydraulic jack 9 is a core part of the servo feed assembly 10, which realizes a telescopic movement based on hydraulic principles. The hydraulic jack 9 generally includes a cylinder body, a piston, a seal, a guide. The cylinder body is filled with hydraulic oil. When the piston is subjected to a pressure, the piston reciprocates in the cylinder body, thereby driving the part connected to it to move.

The control system of the servo feed assembly 10 is responsible for receiving commands from the controller 12 and controlling the telescopic movement of the hydraulic jack 9. The control system generally includes a solenoid valve, a sensor, the controller 12 and a power supply. The solenoid valve is used for controlling the flow direction and rate of the hydraulic oil, enabling precise control on the telescoping speed and displacement of the hydraulic jack 9. The sensor is used for monitoring parameters such as the position and speed of the hydraulic jack 9 in real time and feeding the information back to the controller 12. Based on these information and preset welding parameters, the controller 12 calculates the gap and contact pressure to be regulated and issues the corresponding control commands.

By designing the first clamping portion and the second clamping portion in a coaxial arrangement, the coaxiality of the clamped workpieces in the welding process is ensured, and the welding quality and stability are improved. The precise control on the rotation driving element, the clutch 4 and the servo feed assembly 10 by the controller 12 enables precise adjustment of the rotational speed of the flywheel set 6 and the displacement of the tailstock 8, thereby improving the controllability and precision of the welding. Through the real-time monitoring on the strain gauge 13 and the infrared temperature monitor 15, abnormalities in the welding process, such as excessive torque and excessive temperature, can be detected in real time, thereby avoiding welding defects and safety accidents.

### Example II

In another exemplary embodiment of the present disclosure, FIG. 1 shows an operating method of a pressure-regulating inertial friction welding system, which is operated by means of the pressure-regulating inertial friction welding system of Example I.

The operating method of a pressure-regulating inertial friction welding system includes:
the clamping assembly 7 on the flywheel set 6 and the clamping assembly 7 on the tailstock 8 clamp the rotation workpiece to be welded 16 and the feed workpiece to be welded 17 respectively, an attaching surface of a strain gauge 13 is adhered onto the feed workpiece to be welded 17 corresponding to the tailstock 8, and the temperature monitor monitors temperatures at friction interface between the rotation workpiece to be welded 16 and the feed workpiece to be welded 17;
the rotation driving element is started to drive the clamping assembly 7 on the flywheel set 6 and the clamped rotation workpiece to be welded 16 to rotate, and upon the rotational speed meets the requirement, the power between the rotation driving element and the rotation workpiece to be welded 16 is cut off by means of the clutch 4;
the servo feed assembly 10 pushes the tailstock 8 and the clamped feed workpiece to be welded 17 to move to bring the rotation workpiece to be welded 16 and the feed workpiece to be welded 17 to come into contact and apply a pressure between the rotation workpiece to be welded 16 and the feed workpiece to be welded 17;
the temperature monitor continuously collects the temperatures at the friction interface between the rotation workpiece to be welded 16 and the feed workpiece to be welded 17, and sends the temperature to the controller 12, and the strain gauge 13 measures and obtains strain data of the feed workpiece to be welded 17 and sends the strain data to the controller 12; and
the controller 12 controls the pressure applied between the rotation workpiece to be welded 16 and the feed workpiece to be welded 17 by the servo feed assembly 10 based on data monitored by the temperature monitor and/or the strain gauge 13, to enable well welding of joints of the rotation workpiece to be welded 16 and the feed workpiece to be welded 17.

A target temperature range of the friction interface is preset, and the servo feed assembly 10 is controlled to increase, reduce or maintain the pressure applied between the rotation workpiece to be welded 16 and the feed workpiece to be welded 17, to maintain the temperature of the friction interface within the target temperature range.

A target torque range of the feed workpiece to be welded 17 is preset, a real-time torque collected by the strain gauge 13 is compared to the target torque range, and the servo feed assembly 10 is controlled to maintain the real-time torque within the target torque range.

Specifically, with reference to FIG. 1, the operating method of a pressure-regulating inertial friction welding system includes the following.

The infrared temperature monitor 15 is arranged adjacent to the friction interface, such that the friction interface in the welding process is covered within a monitoring range of the infrared temperature monitor, the strain-type torque meter 14 is arranged adjacent to the feed workpiece to be welded 17 on the feed side, and the strain gauge 13 is adhered to an outer cylindrical surface, unclamped by clamping assembly 7, of the feed workpiece to be welded 17 on the feed side; the controller 12 is used to control the inertial friction welding machine to start operation, the infrared temperature monitor 15 and the strain-type torque meter 14 transmit the obtained temperature data and torque data to the controller 12, and the controller controls the servo feed assembly 10 to regulate the friction pressure in the welding process after the obtained temperature data and torque data is processed by the data processing and control program.

Before welding starts, a target temperature is set in the data processing and control program, and the monitoring area, covering the friction interface, of the infrared temperature monitor 15 is selected; after the welding starts, the infrared temperature monitor 15 continuously collects and sends temperature data to the controller 12, and the data processing and control program compares the collected temperature with the target temperature; when the collected temperature is higher than the target temperature, the servo feed assembly 10 is controlled to reduce the friction pressure; when the collected temperature is lower than the target temperature, the servo feed assembly 10 is controlled to increase the friction pressure to a preset value. The above monitoring and regulating process is repeated until the welding ends.

Before the welding starts, a target torque is set in the data processing and control program. After the welding starts, the strain-type torque meter 14 continuously collects and sends the torque data to the controller 12, and the data processing and control program compares the collected torque with the target torque; when the collected torque is greater than the target torque, the servo feed assembly 10 is controlled to reduce the friction pressure; and when the collected torque is less than the target torque, the servo feed assembly 10 is controlled to increase the friction pressure to the preset value. The above monitoring and regulating process is repeated until the welding ends.

In the inertial friction welding process, when the temperature of the friction interface is too high, metal near the interface undergoes microstructure deterioration such as grain coarsening and strengthening phase dissolving, reducing the performance of joint. Moreover, the deformation resistance of the overheated metal decreases significantly, and buckling deformation is likely to occur, which affects the formation of the joint. Heat generated by friction accounts for most of heat generated in the inertial friction welding process, and is a main factor for heating the workpieces. Friction heat generation power P is related to relative velocity v and friction force f, with P=vf, and the friction force f is directly proportional to positive pressure fn, with f=μfn, and the friction force f in the inertial friction welding process is directly proportional to the friction pressure p, so that the friction heat generation power of the friction interface can be changed by regulating the friction pressure p. When the temperature of the friction interface is too high, the friction heat generation power can be reduced by lowering the friction pressure; when the interface heat generation power is less than the thermal dissipation from the workpiece heat conduction, heat convection and heat radiation, the temperature of the friction interface will decrease, thereby avoiding damages to the formation and performance of the joint due to over-high temperature of the workpieces.

Furthermore, in the inertial friction welding process, the deformation resistance decreases of the material after it reaches the thermoplastic state. For some special materials and thin-walled structures, buckling deformation is likely to occur under the action of a large friction torque, which affects the welding formation and quality. Friction torque M is proportional to the friction force f, thus the friction force and the friction torque of the friction interface can be changed by regulating the friction pressure. When an excessive friction torque is monitored, the friction pressure can be reduced to reduce the friction force and the friction torque, avoiding buckling deformation.

The examples described above are merely preferred examples of the present disclosure, and are not intended to limit the present disclosure. For those skilled in the art, various changes and variations may be made to the present disclosure. Any modifications, equivalent substitutions, improvements, etc. made within the spirit and principles of the present invention shall be included within the scope of protection of the present invention.

What is claimed is:

1. A pressure-regulating inertial friction welding system, comprising:
an inertial friction welding machine comprising a flywheel set and a tailstock arranged oppositely, the flywheel set and the tailstock being provided with clamping assemblies configured for clamping a rotation workpiece to be welded and a feed workpiece to be welded respectively, the flywheel set being connected to a rotation driving element via a clutch, and the tailstock being connected to a servo feed assembly; and
a control assembly comprising a controller, a strain gauge and a temperature monitor, the strain gauge having an attaching surface to be attached to the feed workpiece to be welded corresponding to the tailstock and being capable of measuring and obtaining strain data of the feed workpiece to be welded and sending the strain data to the controller, the temperature monitor having a monitoring area covering welding zone between the rotation workpiece to be welded and the feed workpiece to be welded, and the temperature monitor being capable of sending a temperature of the welding zone to the controller; and the controller being configured to control the servo feed assembly to regulate a pressure between the rotation workpiece to be welded and the feed workpiece to be welded.

2. The pressure-regulating inertial friction welding system of claim 1, wherein one, on the flywheel set, of the clamping assemblies forms a first clamping portion, an other, on the tailstock, of the clamping assemblies forms a second clamping portion, and the first clamping portion and the second clamping portion are coaxially arranged.

3. The pressure-regulating inertial friction welding system of claim 2, wherein the inertial friction welding machine further comprises a workbench, the workbench is provided with guide rails parallel to a movement direction of the servo feed assembly, and the tailstock matches with the guide rails to be slidably mounted on the workbench.

4. The pressure-regulating inertial friction welding system of claim 1, wherein the strain gauge is connected to the controller via a strain-type torque meter, and the temperature monitor is an infrared temperature monitor.

5. The pressure-regulating inertial friction welding system of claim 1, wherein an output end of the rotation driving element is connected to an input end of the clutch via a driving shaft, and an output end of the clutch is connected to the flywheel set via a rotating spindle.

6. The pressure-regulating inertial friction welding system of claim 5, wherein the rotation driving element and the clutch are connected to the controller, and the controller is configured to control operating parameters of the rotation driving element and operating states of the clutch.

7. The pressure-regulating inertial friction welding system of claim 1, wherein the servo feed assembly comprises a hydraulic jack, one end of the hydraulic jack is fixed onto the inertial friction welding machine, and an other end of the hydraulic jack is connected to the tailstock to drive the tailstock to move relative to the flywheel set.

8. An operating method of a pressure-regulating inertial friction welding system, operated by means of the pressure-regulating inertial friction welding system of claim 1, comprising:
clamping the rotation workpiece to be welded and the feed workpiece to be welded by the one, on the flywheel set, of the clamping assemblies and the other, on the tailstock, of the clamping assemblies respectively, attaching the attaching surface of the strain gauge onto the feed workpiece to be welded corresponding to the tailstock, and monitoring, by a temperature monitor, a temperature at a friction interface between the rotation workpiece to be welded and the feed workpiece to be welded;
starting the rotation driving element to drive the one, on the flywheel set, of the clamping assemblies and the rotation workpiece to be welded to rotate to reach a set rotational speed, and cutting off power between the rotation driving element and the rotation workpiece to be welded by means of the clutch;
pushing, by the servo feed assembly, the tailstock and the feed workpiece to be welded to move to bring the rotation workpiece to be welded and the feed workpiece to be welded to come into contact and apply a pressure between the rotation workpiece to be welded and the feed workpiece to be welded;
continuously collecting the temperature at the friction interface between the rotation workpiece to be welded and the feed workpiece to be welded, and sending the temperature to the controller by the temperature monitor, and measuring and obtaining the strain data of the feed workpiece to be welded and sending the data to the controller by the strain gauge; and
controlling, by the controller, the pressure applied between the rotation workpiece to be welded the feed workpiece to be welded from the servo feed assembly based on the temperature collected by the temperature monitor and/or the strain data obtained by the strain gauge, to enable well welding of joint between the rotation workpiece to be welded and the feed workpiece to be welded.

9. The operating method of a pressure-regulating inertial friction welding system of claim 8, wherein the operating method comprises: presetting a target temperature range of the friction interface, and controlling the servo feed assembly to increase, reduce or maintain the pressure applied between the rotation workpiece to be welded and the feed workpiece to be welded, to maintain the temperature of the friction interface within the target temperature range.

10. The operating method of a pressure-regulating inertial friction welding system of claim 8, wherein the operating method comprises: presetting a target torque range of the feed workpiece to be welded, comparing a real-time torque collected by the strain gauge to the target torque range, and controlling the servo feed assembly to maintain the real-time torque within the target torque range.

11. The operating method of a pressure-regulating inertial friction welding system of claim 8, wherein one, on the flywheel set, of the clamping assemblies forms a first clamping portion, an other, on the tailstock, of the clamping assemblies forms a second clamping portion, and the first clamping portion and the second clamping portion are coaxially arranged.

12. The operating method of a pressure-regulating inertial friction welding system of claim 11, wherein the inertial friction welding machine further comprises a workbench, the workbench is provided with guide rails parallel to a movement direction of the servo feed assembly, and the tailstock matches with the guide rails to be slidably mounted on the workbench.

13. The operating method of a pressure-regulating inertial friction welding system of claim 8, wherein the strain gauge is connected to the controller via a strain-type torque meter, and the temperature monitor is an infrared temperature monitor.

14. The operating method of a pressure-regulating inertial friction welding system of claim 8, wherein an output end of the rotation driving element is connected to an input end of the clutch via a driving shaft, and an output end of the clutch is connected to the flywheel set via a rotating spindle.

15. The operating method of a pressure-regulating inertial friction welding system of claim 14, wherein the rotation driving element and the clutch are connected to the controller, and the controller is configured to control operating parameters of the rotation driving element and operating states of the clutch.

16. The operating method of a pressure-regulating inertial friction welding system of claim 11, wherein the servo feed assembly comprises a hydraulic jack, one end of the hydraulic jack is fixed onto the inertial friction welding machine, and an other end of the hydraulic jack is connected to the tailstock to drive the tailstock to move relative to the flywheel set.

17. The operating method of a pressure-regulating inertial friction welding system of claim 11, wherein the operating method comprises: presetting a target temperature range of the friction interface, and controlling the servo feed assembly to increase, reduce or maintain the pressure applied between the rotation workpiece to be welded and the feed workpiece to be welded, to maintain the temperature of the friction interface within the target temperature range.

18. The operating method of a pressure-regulating inertial friction welding system of claim 11, wherein the operating method comprises: presetting a target torque range of the feed workpiece to be welded, comparing a real-time torque collected by the strain gauge to the target torque range, and controlling the servo feed assembly to maintain the real-time torque within the target torque range.

19. The operating method of a pressure-regulating inertial friction welding system of claim 12, wherein the operating method comprises: presetting a target temperature range of the friction interface, and controlling the servo feed assembly to increase, reduce or maintain the pressure applied between the rotation workpiece to be welded and the feed workpiece to be welded, to maintain the temperature of the friction interface within the target temperature range.

20. The operating method of a pressure-regulating inertial friction welding system of claim 12, wherein the operating method comprises: presetting a target torque range of the feed workpiece to be welded, comparing a real-time torque collected by the strain gauge to the target torque range, and controlling the servo feed assembly to maintain the real-time torque within the target torque range.
